(19) United States
(12) Patent Application Publication
(10) Pub. No.: US 2026/0278637 A1
(43) Pub. Date: Sep. 17, 2026

(54) ONLINE ADVERTISING AGENCY SYSTEM, ONLINE ADVERTISING AGENCY METHOD, AND COMPUTING DEVICE THEREOF

(71) Applicant: FU-SONG HSU, Taoyuan City (TW)

(72) Inventor: FU-SONG HSU, Taoyuan City (TW)

(21) Appl. No.: 19/562,839

(22) Filed: Mar. 11, 2026

Related U.S. Application Data
(60) Provisional application No. 63/770,983, filed on Mar. 13, 2025.

(51) Int. Cl. G06Q 30/0242; G06Q 30/0241

(52) U.S. Cl. CPC G06Q 30/0242; G06Q 30/0276; G06Q 30/0277

(57) ABSTRACT

The present disclosure provides an online advertising agency system, an online advertising agency method, and a computing device thereof. A first server provides a user interface to log into an account, upload an advertising draft, and submit a review request for a specific social media platform. A database server centrally stores account data, the advertising draft, and the review request. A second server obtains the review request from the database server and activates an advertising review model to perform an intelligent preliminary review according to target platform regulations and returns a review report to the database server. After the review is completed, a user logged into the first server can obtain a review completion notification and related results from the database server.

### CROSS-REFERENCE TO RELATED APPLICATION

This application claims priority to and the benefit of U.S. Provisional Patent Application Ser. No. 63/770,983, filed on Mar. 13, 2025, the disclosure of which is incorporated by reference herein.

### FIELD

The present disclosure relates to an online agency technology, and more particularly, to an online advertising agency system, an online advertising agency method, and a computing device thereof.

### BACKGROUND

Current online advertising management systems typically provide various functions for advertising placement and management; however, most existing systems still face many limitations and defects. First, a majority of advertising management systems rely on manual operations, where users must personally set up and adjust advertising content. This is not only time-consuming and prone to errors but also fails to automatically perform precise adjustments based on the actual performance of the advertisements. Consequently, advertising effects often fail to reach an optimal level. Particularly in many small and medium-sized enterprises, there is a lack of professional advertising operations personnel, making it difficult for them to effectively manage and optimize advertisements.

Furthermore, before placing advertisements, users often fail to consider the review of the advertisements. Such situations frequently result in advertising expenses being spent while the advertisements are blocked due to violations of social media platform regulations; in more severe cases, even the accounts may be blocked together. This also affects the user's advertising experience and the efficiency of advertising placement. Moreover, many systems cannot fully provide in-depth analysis of advertising benefits, especially lacking benefit evaluation tools based on algorithms, making it impossible for users to truly understand advertising performance or make timely and effective optimization decisions based on data.

In addition, current advertising management systems have not fully resolved the issue of cross-platform operations. Many advertisers need to switch between multiple platforms and manually perform setup and data interfacing for different accounts. This mode of operation is extremely cumbersome and prone to errors or delays during data integration and analysis. These platforms often fail to provide a unified and efficient interface, allowing users to easily integrate and manage advertising account data from different sources.

Therefore, although existing technologies are capable of providing basic advertising placement functions, there are still many deficiencies in terms of the degree of automation, data analysis capabilities, and cross-platform integration. These defects prevent users from effectively improving advertising benefits and increase the difficulty and error rate of operations.

### SUMMARY

One object of the preferred embodiments of the present disclosure is to provide an online advertising agency system, an online advertising agency method, and a computing device thereof. Based on the defects of existing systems, a more efficient, intelligent, and easy-to-operate online advertising agency system is provided to solve the deficiencies of automation, intelligence, data integration, and benefit evaluation in current technologies, thereby significantly improving advertising placement effects and user experience.

In view of the above, a preferred embodiment of the present disclosure provides an online advertising agency system, comprising a client device, a first server, a second server, and a database server. The first server is configured to provide at least one user interface. The second server is configured to provide a back-end management computing interface. The database server is configured to accept data access from the first server and the second server. The client device has a display and an input unit and is configured to: display the user interface on the display; receive a first input via the input unit to generate a login request; and receive a second input via the input unit to generate an advertising draft and an advertising review request for a first social media platform to be placed and send the login request, the advertising draft, and the advertising review request to the first server.

The first server is further configured to: receive the login request from the client device to grant an advertising review permission associated with an account to the client device; receive, in response to the advertising review permission being granted to the client device, the advertising draft and the advertising review request from the client device; and upload the advertising review request and the advertising draft to the database server to be stored therein. The second server is further configured to: obtain the advertising review request from the database server; activate, in response to the advertising review request, an advertising review model to perform an intelligent preliminary review on the advertising draft based on a regulation of the first social media platform to be placed and generate a review report; and upload the review report to the database server. The first server is further configured to receive the review report from the database server.

Another preferred embodiment of the present disclosure provides an online advertising agency method for an online advertising agency system. The online advertising agency system includes a first server, a second server, a database server, and a client device. The online advertising agency method comprises: storing an account by the database server; providing at least one user interface by the first server; displaying the at least one user interface by the client device; receiving a first input on the at least one user interface by the client device via an input unit to generate a login request associated with the account; receiving the login request from the client device by the first server to grant an advertising review permission associated with the account to the client device; receiving a second input on the at least one user interface by the client device via the input unit to generate an advertising draft and an advertising review request for a first social media platform to be placed; receiving, in response to the advertising review permission being granted to the client device, the advertising draft and the advertising review request from the client device by the first server; uploading, by the first server, the advertising review request and the advertising draft to the database server to be stored therein; obtaining the advertising review request from the database server by the second server; activating, in response to the advertising review request, an advertising review model by the second server to perform an intelligent preliminary review on the advertising draft based on a regulation of the first social media platform and generate a review report; uploading the review report to the database server by the second server; and receiving the review report from the database server by the first server.

Another preferred embodiment of the present disclosure provides a computing device for an online advertising agency system. The online advertising agency system includes a database server and a client device. The computing device includes a storage unit and a processor. The storage unit includes one or more program codes. The processor is coupled to the storage unit and configured to execute the one or more program codes to: receive a login request from the client device to grant an advertising review permission associated with the account to the client device; receive, in response to the advertising review permission being granted to the client device, an advertising draft and an advertising review request from the client device; upload the advertising review request and the advertising draft to the database server; obtain the advertising review request from the database server; activate, in response to the advertising review request, an advertising review model to perform an intelligent preliminary review on the advertising draft based on a regulation of a first social media platform to be placed and generate a review report; upload the review report to the database server; and receive the review report from the database server.

In summary, the preferred embodiments of the present disclosure employ an innovative online advertising agency system. By performing authorized links between a user's social media advertising account and a platform account of the present disclosure, fully automated management of advertising placement is achieved. The system utilizes advanced artificial intelligence technology to review advertisements, which accurately identifies the compliance of advertising content. Therefore, the advertising placement effect is effectively enhanced.

To make the aforementioned and other objects, features, and advantages of the present disclosure more comprehensible, preferred embodiments are described in detail below with reference to the accompanying drawings.

### BRIEF DESCRIPTION OF THE DRAWINGS

The accompanying drawings are provided to facilitate further understanding of the present disclosure and are incorporated into and constitute a part of the specification of the present disclosure. The drawings illustrate exemplary embodiments of the present disclosure and, together with the specification, serve to explain the principles of the present disclosure.

FIG. 1 is a system block diagram of an online advertising agency system according to a preferred embodiment of the present disclosure.

FIG. 2 is a schematic diagram of an intelligent advertising review of the online advertising agency system according to an embodiment of the present disclosure.

FIG. 3 is a flowchart of an online advertising agency method according to an embodiment of the present disclosure.

FIG. 4 is a schematic diagram of a data flow of an online advertising agency system according to an embodiment of the present disclosure.

FIG. 5 is a schematic diagram of an intelligent review result of an online advertising agency system according to a preferred embodiment of the present disclosure.

FIG. 6 is a schematic diagram of a data flow of the intelligent review model generating an advertising review model in the online advertising agency system according to a preferred embodiment of the present disclosure.

FIG. 7 is a block diagram of a system architecture of an online advertising agency system according to an embodiment of the present disclosure.

### DETAILED DESCRIPTION

Reference will now be made in detail to the exemplary embodiments of the present disclosure, examples of which are illustrated in the accompanying drawings. Whenever possible, the same reference numbers will be used throughout the drawings and the specification to refer to the same or like parts. In addition, the implementations of the exemplary embodiments are merely one of the ways to realize the inventive concept of the present disclosure, and the following examples are not intended to limit the scope of the present disclosure.

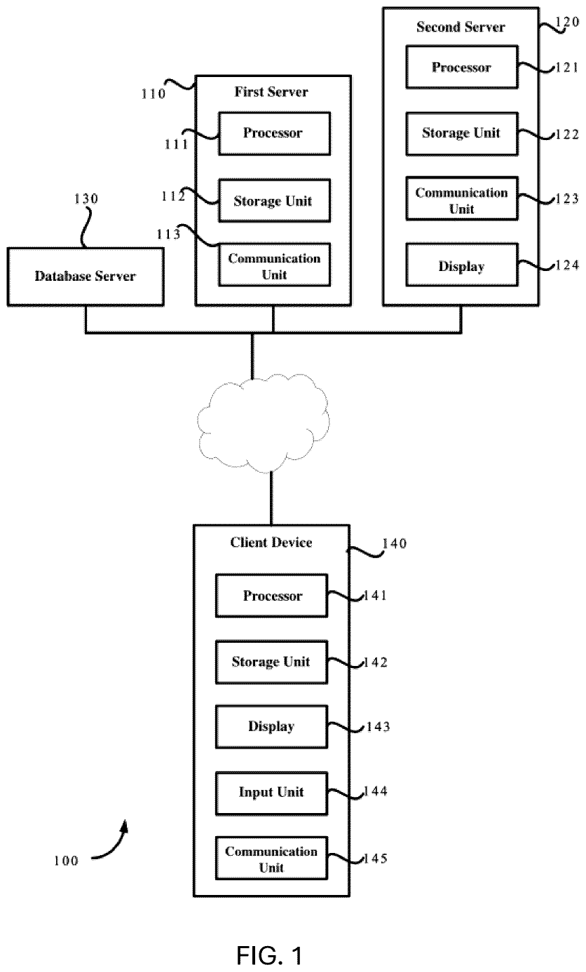

FIG. 1 is a system block diagram of an online advertising agency system 100 according to a preferred embodiment of the present disclosure. Referring to FIG. 1, the online advertising agency system 100 includes a first server 110, a second server 120, a database server 130, and a client device 140. In the present embodiment, the first server 110 is configured to provide a user interface for users to perform front-end tasks such as logging in and applying for accounts.

The first server 110, the second server 120, and the database server 130 may be independently separate cloud servers or may be disposed in the same cloud server. In the present embodiment, the first server 110, the second server 120, the database server 130, and the client device 140 all have communication units to communicate via wired or wireless transmission methods for mutual signal and data transmission.

The database server 130 is, for example, a server providing data storage services and configured to accept data access from the first server 110 and the second server 120 and store user accounts. In one embodiment, the database server 130 employs Amazon Simple Storage Service to store and protect any amount of data for various use cases, such as data lakes, websites, mobile applications, backup and recovery, archives, enterprise applications, IoT devices, and big data analysis.

The first server 110 is configured to provide a front-end user interface and receive a login request from the client device 140. The client device 140 is configured to log into an account and then upload data and/or instructions, and the first server 110 stores the data and/or instructions uploaded by the client device 140 into the database server 130. The first server 110 is an electronic device or a server having a computing function and a networking function. For example, the first server 110 at least includes a processor 111, a storage unit 112, and a communication unit 113. The processor 111 is electrically coupled to the storage unit 112 and the communication unit 113.

The second server 120 is configured to perform back-end management. After obtaining the data and/or instructions uploaded by the client device 140 from the database server 130, the second server 120 performs processing on the data uploaded by the client device 140 according to the obtained instructions. Subsequently, the second server 120 stores the data generated after the processing into the database server 130. The second server 120 is an electronic device or a server having a computing function and a networking function. For example, the second server 120 at least includes a processor 121, a storage unit 122, a communication unit 123, and a display 124. The processor 121 is electrically coupled to the storage unit 122 and the communication unit 123.

The client device 140 is an electronic device used by a user who needs to perform advertising operations. For example, the client device 140 may be implemented by a personal computer, a laptop computer, a tablet computer, or a smartphone. The client device 140 at least includes a processor 141, a storage unit 142, a display 143, an input unit 144, and a communication unit 145. The processor 141 is electrically coupled to the storage unit 142, the display 143, the input unit 144, and the communication unit 145.

The processors 111, 121, and 141 may be, for example, a Central Processing Unit (CPU), a Physics Processing Unit (PPU), a programmable microprocessor, an embedded control chip, a Digital Signal Processor (DSP), an Application Specific Integrated Circuit (ASIC), or other similar devices.

The storage units 112, 122, and 142 may be, for example, any type of fixed or mobile Random Access Memory (RAM), Read-Only Memory (ROM), Flash memory, a hard disk, or other similar devices or combinations of these devices. In the first server 110 and the second server 120, the storage units 112 and 122 include one or more program codes. After being installed, the program codes are respectively executed by the processors 111 and 121. In addition, in the client device 140, the storage unit 142 includes one or more program codes. After being installed, the program codes are executed by the processor 141.

The communication units 113, 123, 145 may be chips or circuits employing Local Area Network (LAN) technology, Wireless LAN (WLAN) technology, or mobile communication technology. Examples of LAN may include Ethernet. Examples of WLAN may include Wi-Fi. Examples of mobile communication technology include Global System for Mobile Communications (GSM), third-Generation (3G), fourth-Generation (4G), fifth-Generation (5G), etc.

The display 143 may be, for example, a Liquid Crystal Display (LCD), a plasma display, or the like. The input unit 144 may be, for example, a keyboard, a mouse, a handwriting tablet, or a touch panel. Alternatively, the input unit 144 may also be an image capturing device for capturing image files. The image capturing device may be, for example, a camera or a camcorder employing a Charge Coupled Device (CCD) lens or a Complementary Metal-Oxide Semiconductor (CMOS) lens.

The hardware architecture of the database server 130 is also designed to include processor, a storage unit, and a communication unit (not shown), similar to those of the first server 110 and the second server 120. In one embodiment, the first server 110 and the second server 120 may be configured to be implemented by the same electronic device. That is, in a case where the electronic device is provided for a front-end user to use an operation interface, the electronic device also functions as back-end management. For example, the electronic device implements the first server 110 and the second server 120 in a manner of virtual machines. In another embodiment, the first server 110 and the second server 120 may also be implemented by two independent electronic devices.

The first server 110, the second server 120, the database server 130, and the client device 140 store respective one or more program codes in their respective storage units and execute corresponding steps and/or functions disclosed in various embodiments of the present disclosure through their respective processors 111, 121, and 141. In addition, the first server 110, the second server 120, the database server 130, and the client device 140 may send or receive interfaces, requests, requirements, and/or advertising drafts disclosed in various embodiments of the present disclosure through their respective communication units 113, 123, and 145, but are not limited thereto.

In the client device 140, the processor 141 receives a user interface from the first server 110 via the communication unit 145 and displays the received user interface via the display 143. The client device 140 can receive an input via the input unit 144 and generate a login request via the user interface. Upon the first server 110 granting the login request, the client device 140 can receive another input via the input unit 144 and generate an advertising draft and an advertising review request for a first social media platform to be placed via the user interface, and send the advertising draft and the advertising review request to the first server 110. In the present embodiment, the user interface may be a collective term for one or more operation interfaces, but is not limited thereto. For example, the user interface may include an account login interface configured to perform account input and login, and a data input screen configured to input an advertising draft and generate an advertising review request.

In the first server 110, the processor 111 is configured to receive the login request from the client device 140 via the communication unit 113 and authorize the client device 140 to log into the account so as to provide services corresponding to the logged-in account. In addition, the processor 111 of the first server 110 is configured to receive the advertising draft and the advertising review request from the client device 140 via the communication unit 113 and perform temporary storage via the storage unit 112. Thereafter, the processor 111 is further configured to upload, via the communication unit 113, the temporarily stored advertising review request and the advertising draft to the database server 130 to be stored therein.

In the second server 120, the processor 121 is configured to obtain, via the communication unit 123, the advertising draft and the advertising review request from the database server 130. Thereafter, the processor 121 of the second server 120 activates the advertising review model to cause the advertising review model to perform an intelligent preliminary review on the advertising draft based on a regulation of the first social media platform to be placed and generate a review report. Upon receiving the review report, the processor 121 is configured to temporarily store the review report in the storage unit 122. Subsequently, the processor 121 is configured to upload the review report to the database server 130 via the communication unit 123 to update the database server 130.

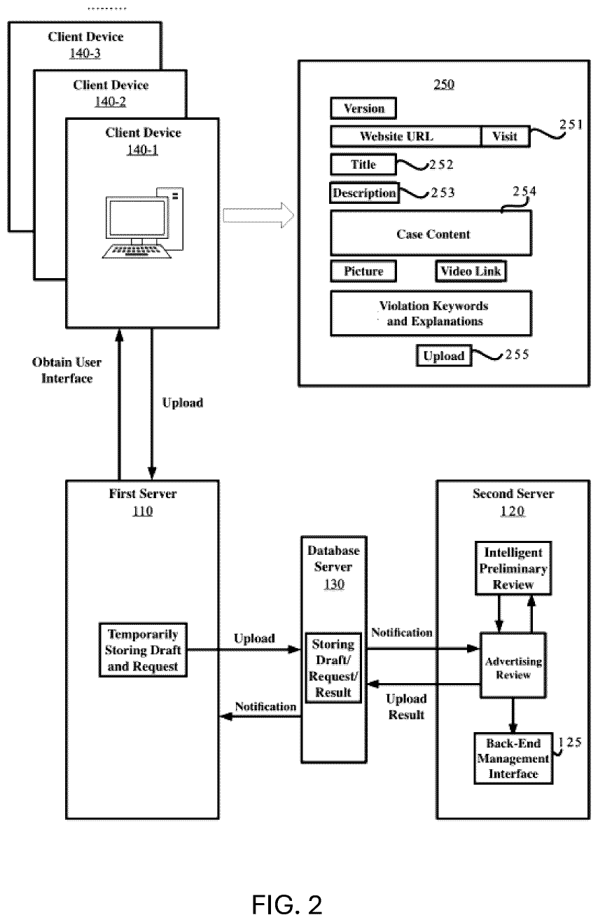

Regarding the various functions and operations of the online advertising agency system, an example of a data flow of the intelligent advertising review is described below. FIG. 2 is a schematic diagram of an intelligent advertising review according to an embodiment of the present disclosure. Referring to FIG. 2, in the present embodiment, the first server 110 and the second server 120 may be implemented by the same electronic device, for example, with two virtual systems, or may be implemented by distinct electronic devices. The client devices 140-1 to 140-3 have the same functions and architecture as the client device 140 shown in FIG. 1. The client devices 140-1 to 140-3 may be implemented by different electronic devices. In the present embodiment, the storage units of the first server 110, the second server 120, and/or the database server 130 may store accounts corresponding to the client devices 140-1 to 140-3, and each account records various different advertising agency services subscribed to by the client devices 140-1 to 140-3, such as: advertising placement, advertising review, advertising design, and/or customer feedback analysis services.

In FIG. 2, the client device 140-1 may receive an input of a corresponding account through its input unit to generate a login request associated with the account. The first server 110 receives the login request from the client device 140-1 and authorizes the client device 140-1 to log into the corresponding account to provide the services corresponding to the logged-in account, such as granting an advertising review permission associated with the account to the client device 140-1. After the client device 140-1 successfully logs into the first server 110, the first server 110 is configured to provide a user interface 250 to be displayed on the display of the client device 140-1 and allow data and/or instructions to be uploaded by the client device 140-1. The client device 140-1 may receive an input on the user interface 250 via its input unit to generate an advertising draft and an advertising review request for a specific social media platform to be placed.

In one embodiment, the client device 140-1 may first connect to the first server 110 to perform registration or account login with the first server 110. After the client device 140-1 successfully logs into the first server 110, the first server 110 is further configured to verify whether an account of a user associated with the client device 140-1 is authorized to access the database server 130. After the first server 110 verifies that the client device 140-1 is authorized to access the database server 130, the client device 140-1 can generate an advertising review request through the user interface 250. The user interface 250 includes options 251 to 255. The options 251 to 255 are provided for the user to input advertising content. Images of the advertising content may also be selected from a folder inside the client device 140-1 used by the user. After the input for the advertising review request is completed, the client device 140-1 may upload the advertising review request and/or the advertising draft to the first server 110. In response to the advertising review permission being granted to the client device 140-1, the first server 110 receives the advertising draft and/or the advertising review request from the client device 140-1, temporarily stores the advertising review request and/or the advertising draft, and uploads them to the database server 130 to be stored therein. The database server 130 is configured to store, in response to the advertising draft sent by the first server 110, the advertising draft and record, in response to the advertising review request sent by the first server 110, the advertising review request. Subsequently, the first server 110 or the database server 130 sends a notification message to the second server 120 to notify the second server 120 that the advertising review request and/or the advertising draft are stored in the database server 130.

In response to receiving the notification message from the database server 130, the second server 120 sends a draft download request to the database server 130 to obtain the advertising draft and the advertising review request from the database server 130. The database server 130 sends the advertising review request and/or the advertising draft to the second server 120 based on the received draft download request. The second server 120 temporarily stores the advertising review request and/or the advertising draft in an internal storage unit thereof. Thereafter, in response to the advertising review request, the second server 120 activates an advertising review model to cause the advertising review model to perform an intelligent preliminary review on the advertising draft based on a regulation of a social media platform to be placed and generate a review report. Next, the second server 120 uploads the review report to the database server 130 and causes the database server 130 to update data stored therein with the review report and associated with the account of the client device 140-1. In response to receiving the review report, the database server 130 sends an advertising review completion notification to the first server 110 to notify the first server 110 that the advertising review is completed. In response to receiving the advertising review completion notification, the first server 110 accesses the database server 130 to receive the review report from the database server 130. In one embodiment, in response to receiving the advertising review completion notification, the first server 110 further notifies the corresponding client device 140-1, for example, by sending a notification to the client device 140-1 via email, short message service (SMS), or other communication software messages.

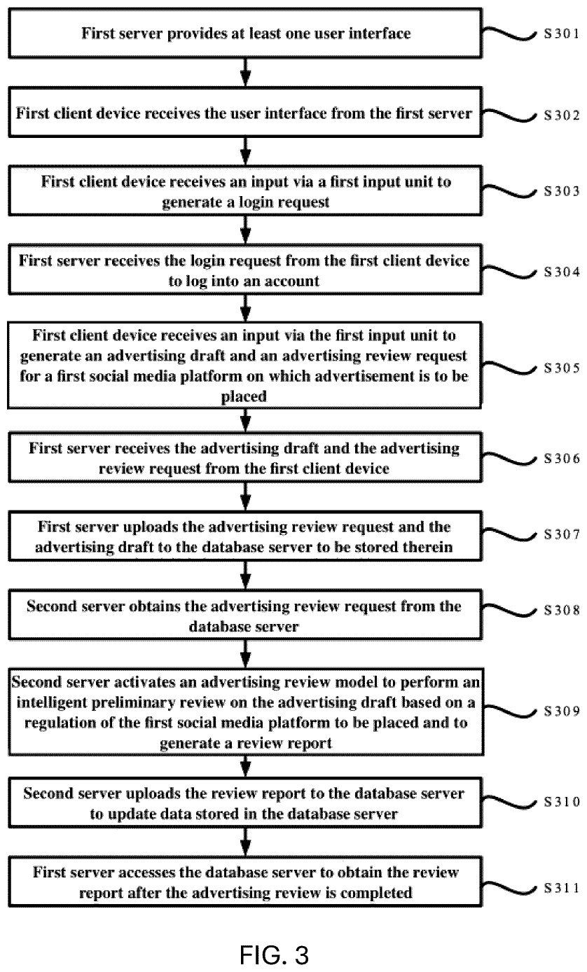

FIG. 3 is a flowchart of an online advertising agency method according to an embodiment of the present disclosure. Referring to FIG. 1, FIG. 2, and FIG. 3, the online advertising agency method includes the following steps:

In step S301, the first server 110 provides at least one user interface 250.

In step S302, the client device 140 receives the user interface 250 from the first server 110. In the present embodiment, the client device 140-1 may connect to a website page provided by the first server 110 via the Internet to receive the website page provided therein as the user interface 250. In other embodiments, the user interface 250 may be a user interface provided by a software application downloaded by the client device 140-1 from the first server 110, but is not limited thereto. In the present embodiment, the user interface refers to a collective term for a single or multiple user interfaces.

In step S303, the client device 140 receives a first input, such as an account, on the user interface 250 via a first input unit, such as a keyboard, a mouse, or a touch panel, to generate a login request associated with the account. In the present embodiment, the user interface may be an account login interface.

In step S304, the first server 110 receives the login request from the client device 140 and grants an advertising review permission associated with the account to the client device 140 based on the login request and the login account.

In step S305, the client device 140 receives another input on the user interface 250 via the input unit to generate, for example, an advertising draft and an advertising review request for a social media platform (such as Facebook, Google, etc.) on which the advertisement is to be placed. Thereafter, the client device 140 can upload the generated advertising draft and advertising review request to the first server 110 via the user interface 250.

In step S306, the first server 110 receives the advertising draft and the advertising review request from the client device 140 in response to the advertising review permission being granted to the client device 140. In a preferred embodiment, the advertising draft and the advertising review request are temporarily stored in a storage unit of the first server 110.

In step S307, the first server 110 uploads the advertising review request and the advertising draft to the database server 130 to be stored therein. In a preferred embodiment, the first server 110 or the database server 130 notifies the second server 120 of the advertising review request and information associated with the account.

In step S308, the second server 120 obtains the advertising review request from the database server 130. In a preferred embodiment, the second server 120 sends a data download request to the database server 130. The database server 130 sends the advertising review request and/or the advertising draft to the second server 120 based on the received data download request. In another preferred embodiment, the second server 120 temporarily stores the advertising review request and/or advertising draft.

In step S309, the second server 120 activates, in response to the advertising review request, an advertising review model to cause the advertising review model to perform an intelligent preliminary review on the advertising draft based on a regulation of the first social media platform to be placed and to generate a review report.

In step S310, the second server 120 uploads the review report to the database server 130 and causes the database server 130 to update data stored therein and associated with the account of the client device 140. In a preferred embodiment, the database server 130 sends an advertising review completion notification to the first server 110 to notify the first server 110 that the advertising review is completed. In other preferred embodiments, the first server 110 notifies the corresponding client device 140 of the completed advertising review via, for example, email, SMS, or other communication software messages.

In step S311, after the advertising review is completed, the first server 110 may send an access request to the database server 130 to cause the database server 130 to send the review report to the first server 110 based on the access request. In one embodiment, after the second server 120 uploads the review report to the database server 130, the first server 110 may send an access request to the database server 130 to cause the database server 130 to send the review report to the first server 110 based on the access request. After the database server 130 sends the review report to the first server 110, the first server 110 may receive the review report from the database server 130.

Through steps S301 to S311, the advertising review is completed.

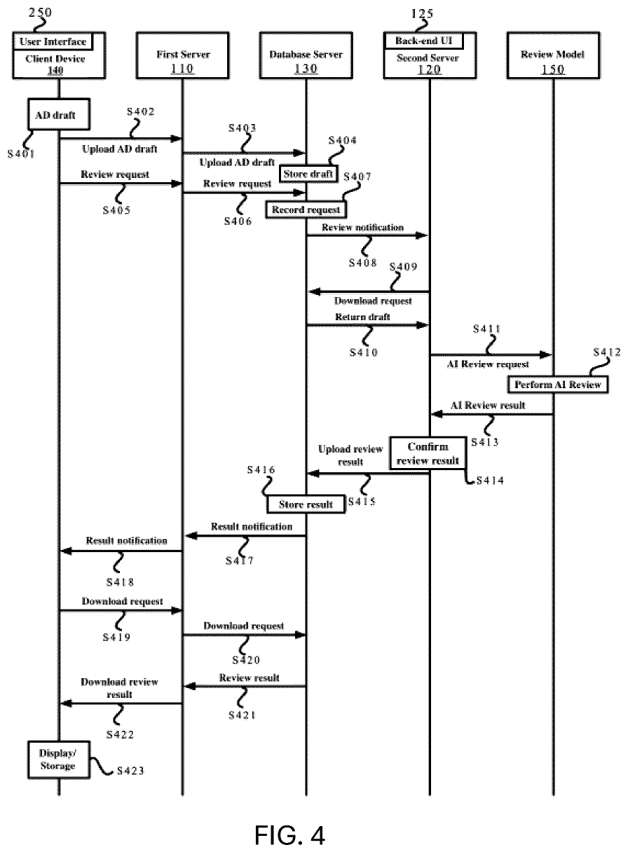

FIG. 4 is a schematic diagram of a data flow of an online advertising agency system according to an embodiment of the present disclosure. Referring to FIG. 1, FIG. 2, and FIG. 4, in the present embodiment, the client device 140 may connect to a website page provided by the first server 110 via the Internet to receive the website page provided therein as the user interface 250 and input an account in an account login interface to log into the account. In step S401, the client device 140 inputs an advertising draft via the user interface 250. In step S402, the client device 140 uploads the generated advertising draft to the first server 110 via the user interface 250. Thereafter, the advertising draft is temporarily stored in the storage unit 112 of the first server 110. In step S403, the first server 110 uploads the advertising draft uploaded by the client device 140 to the database server 130 according to account information. In step S404, the database server 130 stores the uploaded advertising draft in a corresponding database based on the account information.

In step S405, the client device 140 sends, through the user interface 250, an advertising review request for a social media platform to be placed. In step S406, the first server 110 uploads the advertising review request to the database server 130. In step S407, the database server 130 stores the advertising review request in the corresponding database based on the account information.

In step S408, the database server 130 sends a notification to the second server 120 based on the uploaded advertising review request and the account information. In step S409, the second server 120 sends a draft download request to the database server 130. In step S410, the database server 130 returns the advertising draft to the second server 120 to complete a draft distribution process. In another preferred embodiment, the second server 120 temporarily stores the advertising review request and/or advertising draft in the storage unit 122.

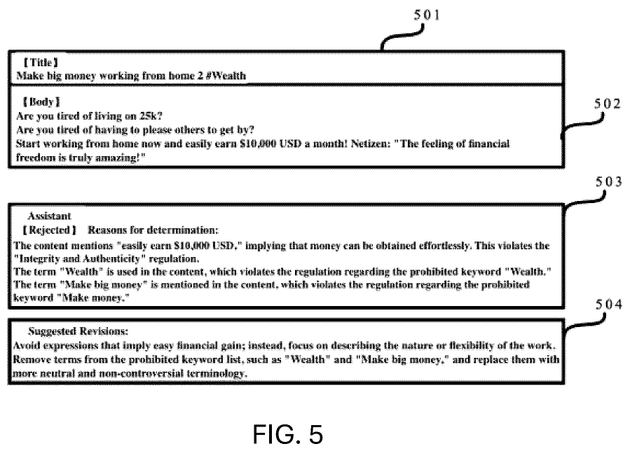

In step S411, the second server 120 sends an intelligent review request to the intelligent review model 150. In step S412, the intelligent review model 150 performs an intelligent review on the advertising draft to generate a review report. FIG. 5 is a schematic diagram of an intelligent review report of an online advertising agency system according to a preferred embodiment of the present disclosure. Referring to FIG. 5, the present embodiment takes an intelligent review report indicating rejection of the advertising draft as an illustrative example. In the present embodiment, reference numeral 501 denotes an advertising title field; reference numeral 502 denotes an advertising text field; reference numeral 503 denotes a result and reason field; and reference numeral 504 denotes a suggestion field. In step S413, the intelligent review model 150 returns an intelligent review result to the second server 120. In the present embodiment, the intelligent review result includes the review report generated by the intelligent review model 150. In step S414, the second server 120 sends the intelligent review result to a back-end management interface 125 to execute confirmation for the intelligent review result. In another preferred embodiment, the second server 120 temporarily stores the review report in the storage unit 122.

In step S415, the second server 120 uploads, to the database server 130, the intelligent review result including the review report and information associated with the account. In one embodiment, before uploading, to the database server 130, the intelligent review result and the information associated with the account, the second server 120 sends the intelligent review result to the back-end management interface to present the intelligent review result on the display 124 of the second server for back-end personnel to review and/or edit the intelligent review result. After the intelligent review result is reviewed and/or edited, the back-end management interface 125 may receive an instruction input by the back-end personnel and accordingly upload, to the database server 130, a reviewed and/or edited review result and information associated with the account. In step S416, the database server 130 stores the intelligent review result in a corresponding database based on the information associated with the account. In step S417, after the second server 120 uploads the intelligent review result including the review report to the database server 130, the database server 130 sends an intelligent review result notification to the first server 110.

In step S418, the first server 110 receives the intelligent review result notification from the database server 130 and transmits the intelligent review result notification to the client device 140 in response to the received intelligent review result notification. In a preferred embodiment, the intelligent review result notification is packaged into an email by the first server 110 and then sent to the email inbox corresponding to the client device 140 to notify the client device 140. In another preferred embodiment, the first server 110 may also package the intelligent review result notification into an SMS or other communication software message to notify the client device 140. In step S419, the client device 140 sends a review result download request to the first server 110. In a preferred embodiment, after the client device 140 logs into the first server 110, the review result download request is generated via the input unit. At this time, the first server 110 receives the review result download request from the client device 140. In step S420, the first server 110 sends a download request to the database server 130 based on the review result download request sent by the client device 140.

In step S421, the database server 130 sends the review report to the first server 110 in response to the received download request. In step S422, the first server 110 receives the review report from the database server and transmits the review report to the client device 140. In step S423, the client device 140 displays or stores the review report. Accordingly, the user of the client device 140 can perform modifications to texts or images of the advertising draft based on the result and suggestion of the suggestion field 504 of the review report for the advertising draft to be placed, so as to avoid the advertising draft being taken down by the platform or the account being blocked.

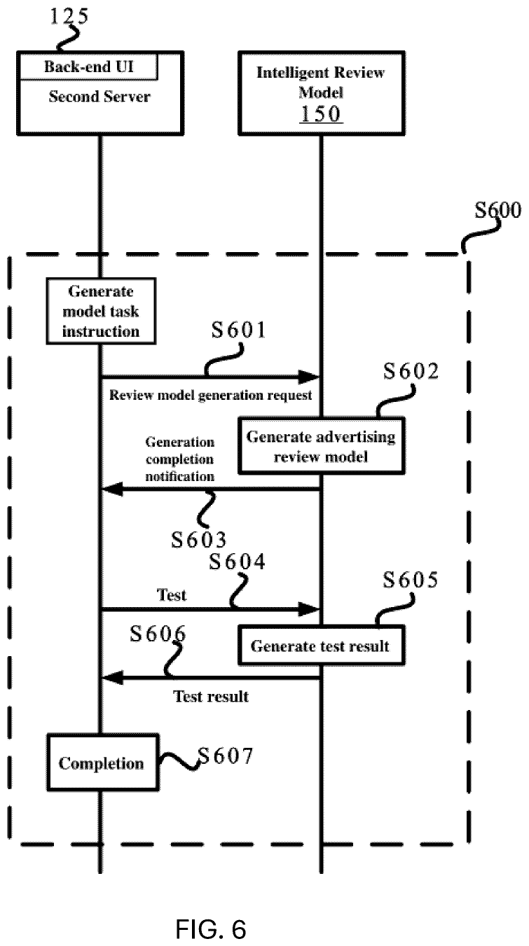

FIG. 6 is a schematic diagram of a data flow of the intelligent review model 150 generating an advertising review model in the online advertising agency system according to a preferred embodiment of the present disclosure. Referring to FIG. 6, the data flow diagram illustrates how the second server 120 and the intelligent review model 150 collaborate to train, generate, and test an advertising review model. In the initial stage, the second server 120 can generate a model task instruction through the back-end management interface 125. In one embodiment, the model task instruction may be a system prompt used as a background setting for the intelligent review model 150 to define the role, professional field, and rules of conduct of the intelligent review model 150. The system prompt may include social media platform regulations, the role played by the intelligent review model 150, and relevant laws and regulations.

In step S601, the second server 120 packages the generated model task instruction into a review model generation request and sends the review model generation request to the intelligent review model 150.

In step S602, the intelligent review model 150 begins generating an advertising review model in response to receiving the review model generation request. In step S603, after the generation of the advertising review model is completed, the intelligent review model 150 issues a generation completion notification to the second server 120 to cause the second server 120 to receive the generation completion notification. Subsequently, in step S604, the second server 120 sends test samples to the generated advertising review model through the back-end management interface 125 for performance validation of the advertising review model.

In step S605, after the advertising review model executes the test for the test samples, a generation test result is generated. In step S606, the intelligent review model 150 transmits the generation test result back to the second server 120 to provide a system evaluation. In step S606, when the second server 120 completes the evaluation, a completion notification is sent to the back-end management computing interface 125.

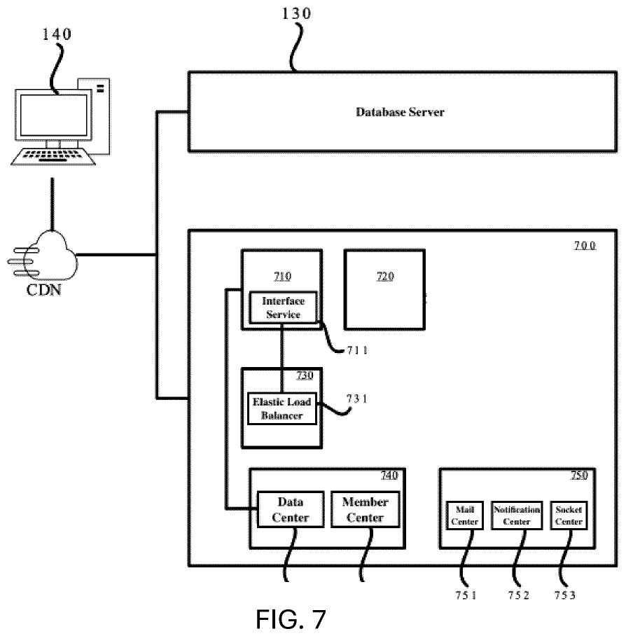

FIG. 7 is a block diagram of a system architecture of an online advertising agency system according to an embodiment of the present disclosure. Referring to FIG. 7, in the present embodiment, the database server 130, a computing device 700, and the client device 140 may be interconnected via a Content Delivery Network (CDN) 701.

The computing device 700 is a cloud server, which includes the first server 110 and the second server 120 and utilizes the processor 111 or 121 to execute various components and various services therein. Herein, the computing device 700 employs Elastic Compute Cloud (EC2) to provide a user interface 710, a back-end management interface 720, an intermediate service 730, a core service 740, and an auxiliary service 750.

The user interface 710 is configured to provide an interface service 711 for the client device 140 to use and renders data to a front-end webpage via the interface service 711. For example, after the client device 140 establishes a connection with the first server 110 in the computing device 700, an advertising review application interface may be displayed on the display 143 of the client device 140 via the interface service 711.

The intermediate service 730 includes an elastic load balancer 731. The elastic load balancer 731 is configured to handle traffic. When the interface service 711 needs to access data or obtain permissions, it transmits a request to the elastic load balancer 731. When there are many requests, shunting may be performed through the elastic load balancer 731.

The core service 740 is configured to communicate with the database server 130 and use data associated with accounts. The core service 740 includes a data center 741 and a member center 742. The member center 742 is configured to record member data of registered members (e.g., account, password, personal data, etc.). Herein, a user needs to perform registration with the first server 110 of the computing device 700 in advance. If a user intends to perform tasks such as advertising agency, advertising top-up, or advertising review, the user must first log into the first server 110 of the computing device 700 before the tasks can be performed.

The auxiliary service 750 is configured to provide transmission functions to send notifications to the client device 140. The auxiliary service 750 includes a mail center 751, a notification center 752, and a socket center 753. The mail center 751 is configured to send emails to a designated email inbox. The notification center 752 is configured for Application-to-Application (A2A) and Application-to-Person (A2P) communications, for example, communication between the first server 110 and the client device 140, communication between the first server 110 and the database server 130, or communication between the second server 120 and the database server 130. The socket center 753 is configured to allow programs on different computers to communicate and exchange data with each other via a network; for example, the first server 110 sends an advertising review request and a advertising draft to and stores them in the database server 130; the first server 110 obtains the advertising review request from the database server 130; the second server 120 uploads the review report to and updates the database server 130; after the advertising review is completed, the first server 110 accesses the database server 130 to obtain the review report. All of these actions utilize the socket center 753 of the auxiliary service 750.

In summary, the preferred embodiments of the present disclosure employ an innovative online advertising agency system. By establishing authorized connections between the user's social media advertising accounts and the platform accounts of the present disclosure, fully automated management of advertising placement is achieved. The present system utilizes advanced artificial intelligence technology to review advertisements and can accurately identify the compliance of advertising content, thereby maximizing advertising benefits. Therefore, the preferred embodiments of the present disclosure provide a more intelligent, efficient, and easy-to-operate solution, which effectively enhances advertising placement effects.

The specific embodiments proposed in the detailed description of the preferred embodiments are merely used to facilitate the illustration of the technical content of the present disclosure and are not intended to limit the present disclosure narrowly to the aforementioned embodiments. Various changes and modifications made without departing from the spirit of the present disclosure and the scope of the following claims shall fall within the scope of the present disclosure. Therefore, the scope of protection of the present disclosure shall be defined by the appended claims.

What is claimed is:

1. An online advertising agency system, comprising:
a first server configured to provide at least one user interface;
a second server configured to provide a back-end management computing interface;
a database server configured to accept data access from the first server and the second server and store an account; and
a client device having a display and an input unit and configured to:
display the at least one user interface on the display;
receive a first input on the at least one user interface via the input unit to generate a login request associated with the account; and
receive a second input on the at least one user interface via the input unit to generate an advertising draft and an advertising review request for a first community platform to be placed and transmit the login request, the advertising draft and the advertising review request to the first server;
wherein the first server is further configured to:
receive the login request from the client device and grant an advertising review permission associated with the account to the client device based on the login request;
receive the advertising draft and the advertising review request from the client device in response to the advertising review permission being granted to the client device; and
upload the advertising review request and the advertising draft to the database server to be stored therein;
wherein the second server is further configured to:
obtain the advertising review request from the database server;
activate, in response to the advertising review request, an advertising review model to perform an intelligent preliminary review on the advertising draft based on a regulation of the first social media platform to be placed and to generate a review report; and
upload the review report to the database server;
wherein the first server is further configured to receive the review report from the database server.

2. The online advertising agency system of claim 1, wherein the database server is further configured to:
store the advertising draft in response to the advertising draft sent by the first server; and
record the advertising review request in response to the advertising review request sent by the first server.

3. The online advertising agency system of claim 1, wherein the second server is further configured to:
send a draft download request to the database server before obtaining the advertising draft from the database server.

4. The online advertising agency system of claim 1, wherein the second server is further configured to:
upload, after generating the review report, the review report to the database server and send a review result to the back-end management computing interface.

5. The online advertising agency system of claim 1, wherein the first server is further configured to:
receive an intelligent review result notification from the database server after the second server uploads the review report to the database server; and
send the intelligent review result notification to the client device.

6. The online advertising agency system of claim 1, wherein the first server is further configured to:
receive a review result download request from the client device;
send a download request to the database server and receive the review report from the database server; and
send the review report to the client device.

7. The online advertising agency system of claim 1, wherein the client device is further configured to:
receive an intelligent review result notification sent by the first server;
generate a review result download request and send the review result download request to the first server;
receive the review report from the first server; and
display the review report on the display or store the review report.

8. The online advertising agency system of claim 1, wherein the second server is further configured to:
send a model task instruction to an intelligent review model to generate the advertising review model; and
receive a generation completion notification sent by the intelligent review model.

9. The online advertising agency system of claim 8, wherein the second server is further configured to:
send a test sample to the advertising review model;
receive a generation test result sent by the advertising review model; and
send a completion notification to the back-end management computing interface.

10. An online advertising agency method for an online advertising agency system, the online advertising agency system comprising a first server, a second server, a database server and a client device, and the online advertising agency method comprising:
storing an account by the database server;
providing at least one user interface by the first server;
displaying the at least one user interface by the client device;
receiving a first input on the at least one user interface by the client device via an input unit to generate a login request associated with the account;
receiving the login request from the client device by the first server to grant an advertising review permission associated with the account to the client device;
receiving a second input on the at least one user interface by the client device via the input unit to generate an advertising draft and an advertising review request for a first social media platform to be placed;
receiving, in response to the advertising review permission being granted to the client device, the advertising draft and the advertising review request from the client device by the first server;
uploading, by the first server, the advertising review request and the advertising draft to the database server to be stored therein;
obtaining the advertising review request from the database server by the second server;
activating, in response to the advertising review request, an advertising review model by the second server to perform an intelligent preliminary review on the advertising draft based on a regulation of the first social media platform and generate a review report;
uploading the review report to the database server by the second server; and
receiving the review report from the database server by the first server.

11. The online advertising agency method of claim 10, further comprising:
storing, by the database server, the advertising draft in response to the advertising draft sent by the first server; and
recording, by the database server, the advertising review request in response to the advertising review request sent by the first server.

12. The online advertising agency method of claim 10, further comprising:
sending, by the second server, a draft download request to the database server before obtaining the advertising draft from the database server.

13. The online advertising agency method of claim 10, further comprising:
upgrading, by the second server, the review report to the database server after the review report is generated and sending a review result to a back-end computing management interface.

14. The online advertising agency method of claim 10, further comprising:
receiving, by the first server, an intelligent review result notification from the database server after the second server uploads the review report to the database server; and
sending, by the first server, the intelligent review result notification to the client device.

15. The online advertising agency method of claim 10, further comprising:
receiving, by the first server, a review result download request from the client device;
sending, by the first server, a download request to the database server and receiving the review report from the database server; and
sending, by the first server, the review report to the client device.

16. The online advertising agency method of claim 10, further comprising:
receiving, by the client device, an intelligent review result notification sent by the first server;
generating, by the client device, a review result download request and sending the review result download request to the first server;
receiving, by the client device, the review report from the first server; and
displaying, by the client device, the review report on a display or storing the review report.

17. The online advertising agency method of claim 10, further comprising:
sending, by the second server, a model task instruction to an intelligent review model to generate the advertising review model; and
receiving, by the second server, a generation completion notification sent by the intelligent review model.

18. The online advertising agency method of claim 17, further comprising:
sending, by the second server, a test sample to the advertising review model;
receiving, by the second server, a generation test result sent by the advertising review model; and
sending, by the second server, a completion notification to a back-end management computing interface.

19. A computing device for an online advertising agency system, the online advertising agency system comprising a database server and a client device, the computing device comprising:
a storage unit comprising one or more program codes; and
a processor coupled to the storage unit and configured to execute the one or more program codes to:
receive a login request from the client device and grant an advertising review permission associated with an account to the client device based on the login request;
receive an advertising draft and an advertising review request from the client device in response to the advertising review permission being granted to the client device;
send and store the advertising review request and the advertising draft to the database server;
obtain the advertising review request from the database server;
activate, in response to the advertising review request, an advertising review model to perform an intelligent preliminary review on the advertising draft based on a regulation of a first social media platform to be placed and to generate a review report;
upload the review report to the database server; and
receive the review report from the database server.

20. The computing device of claim 19, wherein the processor is further configured to execute the one or more program codes to:
generate an intelligent review result notification and transmit the intelligent review result notification to the client device after updating the review report to the database server;
receive a review result download request from the client device;
send a download request to the database server and receive the review report; and
send the review report to the client device.
